(19) United States
(12) Patent Application Publication
(10) Pub. No.: US 2014/0211112 A1
(43) Pub. Date: Jul. 31, 2014

(54) DISPLAY DEVICE

(71) Applicant: Japan Display Inc., Tokyo (JP)

(72) Inventors: Yingbao YANG, Tokyo (JP); Takeo KOITO, Tokyo (JP)

(73) Assignee: Japan Display Inc., Tokyo (JP)

(21) Appl. No.: 14/166,316

(22) Filed: Jan. 28, 2014

(30) Foreign Application Priority Data
Jan. 30, 2013 (JP) 2013-016232

(51) Int. Cl. G02B 27/22

(52) U.S. Cl. CPC G02B 27/2214
USPC 349/15; 359/463

(57) ABSTRACT

A display device includes: a display unit including a first surface having a curved surface shape which is a straight line in a first direction and is a curved line in a second direction orthogonal to the first direction; and a parallax adjustment unit that includes a second surface having a curved surface shape which is a straight line in the first direction and is a curved line in the second direction, and is arranged on an image-displaying surface side of the display unit, wherein a distance between the first surface and the second surface at center in the second direction is shorter than a distance between the first surface and the second surface at an end in the second direction.

### CROSS REFERENCES TO RELATED APPLICATIONS

The present application claims priority to Japanese Priority Patent Application JP 2013-016232 filed in the Japan Patent Office on Jan. 30, 2013, the entire content of which is hereby incorporated by reference.

### BACKGROUND

1. Technical Field

The present disclosure relates to a display device that displays an image stereoscopically visible to a user.

2. Description of the Related Art

In recent years, examples of a display device that displays an image include a display device that displays an image stereoscopically (three-dimensionally) visible to a user (viewer), which is referred to as a three-dimensional image display device. For example, the three-dimensional image display device includes a barrier unit arranged on the display surface side of a display unit that displays an image. The barrier unit makes an adjustment to cause part of the image displayed on the display unit to be incident on the right eye of the user and cause the other part thereof to be incident on the left eye of the user. The display device causes different images to reach the left and right eyes of the user by controlling the image to be displayed on the display unit and controlling the barrier unit, so that the image is stereoscopically visible to the user.

The display surface of such a three-dimensional image display device is designed to be a curved surface instead of a flat surface. For example, Japanese Patent Application Laid-open Publication No. 2006-189962 discloses a device that displays a three-dimensional image on a cylindrical display surface so that the three-dimensional shape of an object to be displayed can be observed at its entire circumference.

In a case in which a display surface has a curved surface shape, specifically, a curved surface shape which is a straight line in one direction and is a curved line in the other direction orthogonal to the former direction, the state of the solid of a three-dimensional image may be different at the center of the display surface and the ends of the display surface (the ends in the direction along a curved line). Specifically, at the ends of the display surface, the three-dimensional image may be difficult to be stereoscopically visible or difficult to be seen.

### SUMMARY

According to an aspect, a display device comprises: a display unit comprising a first surface having a curved surface shape which is a straight line in a first direction and is a curved line in a second direction orthogonal to the first direction; and a parallax adjustment unit that comprises a second surface having a curved surface shape which is a straight line in the first direction and is a curved line in the second direction, and is arranged on an image-displaying surface side of the display unit, wherein a distance between the first surface and the second surface at center in the second direction is shorter than a distance between the first surface and the second surface at an end in the second direction.

Additional features and advantages are described herein, and will be apparent from the following Detailed Description and the figures.

### BRIEF DESCRIPTION OF THE FIGURES

FIG. 1 is a block diagram illustrating an example of the configuration of a display device according to an embodiment;

FIG. 2 is a perspective view illustrating an example of the configuration of a backlight, a display unit, and a barrier unit of the display device illustrated in FIG. 1;

FIG. 3 is a perspective view illustrating a relation between a pixel of the display unit and a unit region of the barrier unit;

FIG. 4 is a schematic cross-sectional view representing a cross-sectional structure of a module to which the display unit and the barrier unit are mounted;

FIG. 5 is a circuit diagram representing a pixel array of the display unit;

FIG. 6A is a schematic diagram of a pixel in performing color display;

FIG. 6B is a schematic diagram of a pixel in performing monochrome display;

FIG. 7 is a schematic diagram of a relation of parameters for an image at a predetermined position of the display device when viewed with the right eye;

FIG. 8 is a schematic diagram of a relation of parameters for an image at the predetermined position of the display device when viewed with the left eye;

FIG. 9 is a graph illustrating a relation of the shift in distance between the position of a pixel perceivable at a predetermined position and a line extending in a normal direction of the first surface from the predetermined position;

FIG. 10 is a graph illustrating the relation of the shift in distance between the position of the pixel perceivable at the predetermined position and the line extending in the normal direction of the first surface from the predetermined position;

FIG. 11 is a graph illustrating the relation of the shift in distance between the position of the pixel perceivable at the predetermined position and the line extending in the normal direction of the first surface from the predetermined position in a case in which the surface is flat;

FIG. 12 is a side view illustrating a relation between the display unit and the barrier unit; and

FIG. 13 is a flowchart illustrating an example of the operation of the display device.

### DETAILED DESCRIPTION

An embodiment for implementing the present disclosure will be described in detail in the following order with reference to the accompanying drawings. The order of the description is as follows.
1. Embodiment (Display Device)
A barrier unit is laminated on a display unit, and a display device displays an image three-dimensionally visible to a user.
A surface of the display unit and a surface of the barrier unit have a curved surface shape which is a straight line in a first direction and is a curved line in a second direction.
2. Application Example (Electronic Apparatus)
An example in which the display device according to the embodiment is applied to an electronic apparatus

### 1. EMBODIMENT

The display device according to the embodiment may be applied to a display device that has a multilayered structure of a backlight, a display unit including a reflective electrode and a shutter provided to each pixel, and a barrier unit disposed on the display unit and switching display for each unit region, and displays a three-dimensional image. Examples of the display unit of the display device include a liquid crystal display (LCD) panel and micro electro mechanical systems (MEMS).

The display device according to the embodiment may be applied to any of a display device for monochrome display and a display device for color display. In the display device for color display, one pixel (unit pixel) being a unit forming a color image includes a plurality of sub-pixels. More specifically, in the display device for color display, one pixel includes three sub-pixels of a sub-pixel displaying red (R), a sub-pixel displaying green (G), and a sub-pixel displaying blue (B), for example.

The configuration of a pixel is not limited to the combination of sub-pixels of the three primary colors, RGB. A pixel may be configured such that sub-pixels of the three primary colors (RGB) are added with more sub-pixels of one color or a plurality of colors. More specifically, for example, a pixel may be configured by adding a sub-pixel displaying white (W) to improve luminance, or may be configured by adding at least one sub-pixel displaying a complementary color to expand a range of color reproduction. In the following description, the display device is assumed to be a display device for color display (a display device in which three sub-pixels correspond to one pixel).

Configuration

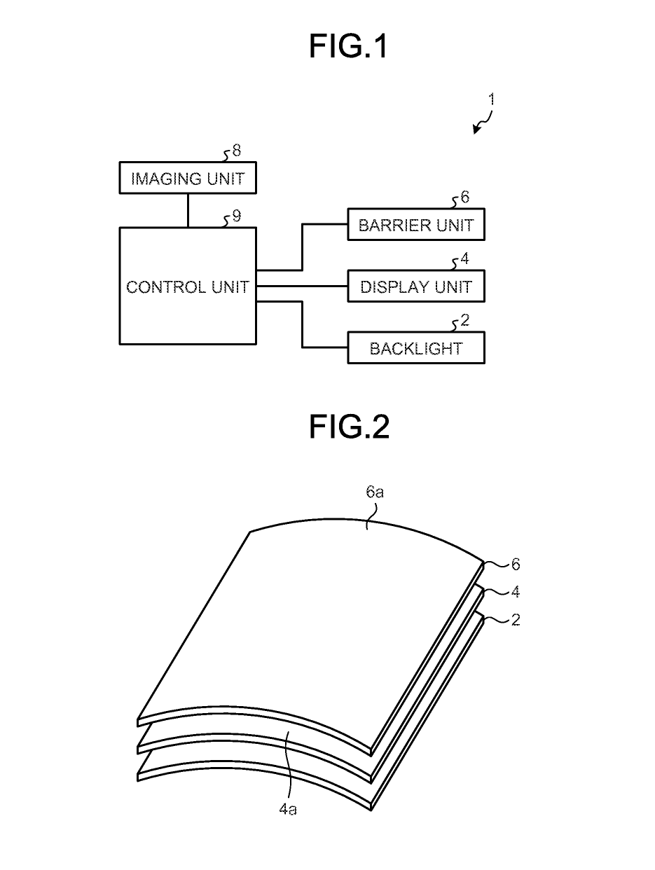

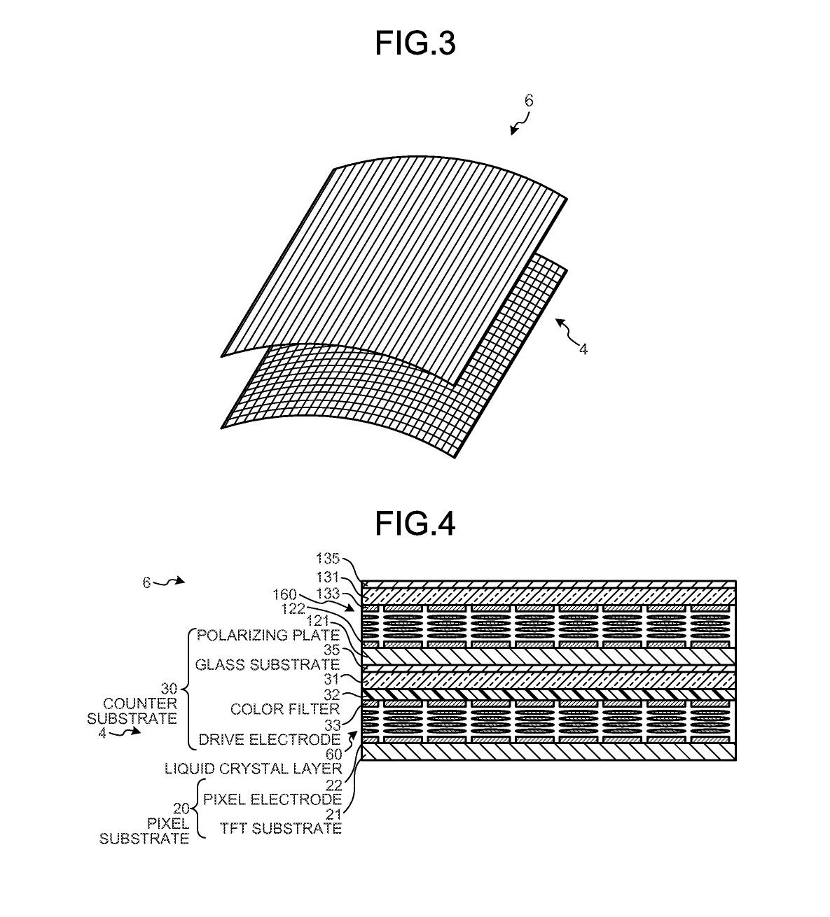

FIG. 1 is a block diagram illustrating an example of the configuration of the display device according to the embodiment of the present disclosure. FIG. 2 is a perspective view illustrating an example of the configuration of the backlight, the display unit, and the barrier unit of the display device illustrated in FIG. 1. FIG. 3 is a perspective view illustrating a relation between a pixel of the display unit and a unit region of the barrier unit. FIG. 2 and FIG. 3 are schematically illustrated, and dimensions and shapes in those drawings are not necessarily the same as actual dimensions and shapes. This display device 1 corresponds to a specific example of a “display device” according to the present disclosure. This barrier unit 6 corresponds to a specific example of a “parallax adjustment unit” according to the present disclosure.

As a specific example, the display device 1 is a display device that displays an image perceivable as a three-dimensional image by a user with naked eyes, the user viewing a screen at a predetermined position. As illustrated in FIG. 1, the display device 1 includes a backlight 2, the display unit 4, the barrier unit 6, an imaging unit 8, and a control unit 9. In the display device 1, the backlight 2, the display unit 4, and the barrier unit 6 are laminated in this order. Alternatively, as another specific example of the display device 1 that displays an image perceivable as a three-dimensional image with naked eyes, the backlight 2, the barrier unit 6, and the display unit 4 may be laminated in this order.

The backlight 2 is a planar lighting device that emits planar light toward the display unit 4. For example, the backlight 2 includes a light source and a light-guiding plate, and outputs the light emitted from the light source, through an emitting surface facing the display unit 4 while having the light scattered on the light-guiding plate.

The display unit 4 is a display device that displays an image. As illustrated in FIG. 3, the display unit 4 is a liquid crystal panel in which a large number of pixels 50 are arranged in a two-dimensional array. The light emitted from the backlight 2 is incident on the display unit 4. The display unit 4 displays an image on a screen by switching between the transmitting and blocking of the incident light for each of the pixels 50. The display unit 4 has a curved surface shape in which a surface thereof on a light emitting side (first surface 4a) has a shape which is a straight line in one direction (first direction) and is a curved line in a direction orthogonal to the first direction (second direction). The first surface 4a has a cross section of a curved line when being cut at any position in the first direction. The curved line shape of the first surface 4a in the second direction protrudes to the light emitting side.

The barrier unit 6 is arranged on the surface of the display unit 4 on which an image is displayed, that is, the surface opposite to the surface facing the backlight 2. In the barrier unit 6, a plurality of unit regions 150 extending in the second direction are arranged adjacent to each other in the first direction. In the barrier unit 6, the unit regions 150 are arranged in columns in the first direction, that is, a direction along which a second surface (barrier surface) 6a makes a curved line. The barrier unit 6 is a liquid crystal panel and switches between the transmitting and blocking of the incident light for each of the unit regions 150. Accordingly, in the second direction, the barrier unit 6 can control a region that transmits an image output from the display unit 4 and a region that blocks the same. Similarly to the display unit 4, the barrier unit 6 has a curved surface shape in which a surface thereof on the light emitting side (second surface 6a) has a shape which is a straight line in one direction (first direction) and is a curved line in a direction orthogonal to the first direction (second direction). The second surface 6a has a cross section of a curved line when being cut at any position in the first direction.

The imaging unit 8 is an apparatus for photographing an image, such as a camera. The imaging unit 8 photographs an image of a region facing the first surface 4a of the display unit 4 and the second surface 6a of the barrier unit 6, and utilizes the display device 1. Examples of a method for acquiring positional information of the user include an eye-tracking technique. In the eye-tracking technique, the user looking at the display device 1 is photographed as image information displayed on the display unit 4.

The control unit 9 controls an operation of each part of the display device 1. Specifically, the control unit 9 controls turning on and off the backlight 2, the amount of light and the intensity of light when the backlight 2 is turned on, an image to be displayed on the display unit 4, an operation (the transmitting and blocking) of each of the unit regions 150 of the barrier unit 6, and an imaging operation of the imaging unit 8.

On the basis of an image acquired by the imaging unit 8, the control unit 9 specifies the position of the user and the positions of the right eye and the left eye of the user. On the basis of the position of the right eye and the position of the left eye of the user, the control unit 9 generates an image to be displayed on the display unit 4 and determines the unit region 150 that transmits light and the unit region 150 that blocks light in the barrier unit 6. Specifically, the control unit 9 causes a pixel 50 of the display unit 4 to display an image for the right eye, the pixel 50 transmitting light to the right eye through the unit region 150 transmissive to light in the barrier unit 6, and causes a pixel 50 of the display unit 4 to display an image for the left eye, the pixel 50 transmitting light to the left eye through the unit region 150 transmissive to light in the barrier unit 6. The barrier unit 6 provides a light transmitting region and a light blocking region in the second direction. Accordingly, the control unit 9 can prevent the image for the right eye from reaching the left eye and can prevent the image for left eye from reaching the right eye. The control unit 9 allows the user to perceive the image as a three-dimensional image by displaying an image for which a parallax generated between the right eye and the left eye according to the position of the image is adjusted. Accordingly, the display device 1 can display an image three-dimensionally visible to the user.

Display Unit 4 and Barrier Unit 6

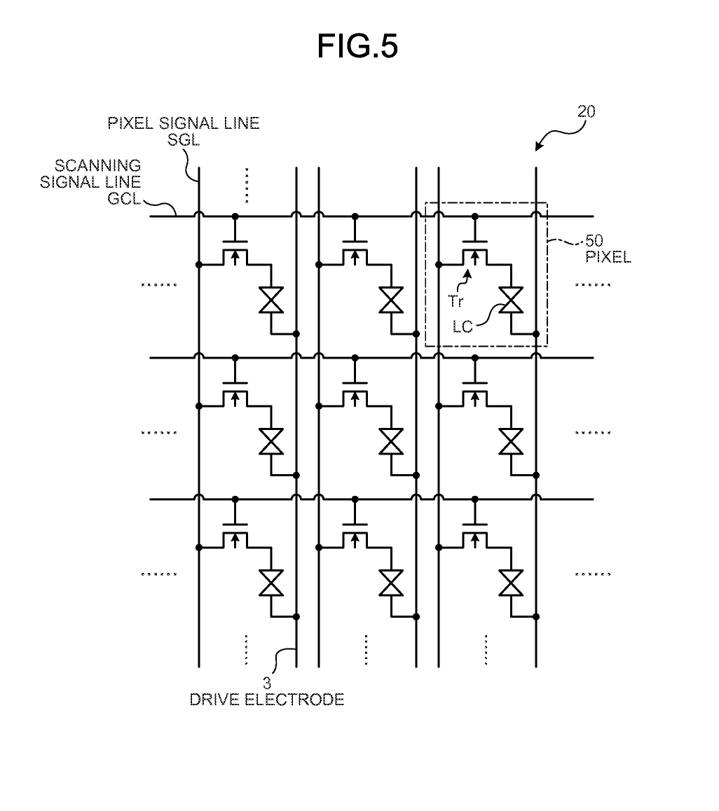

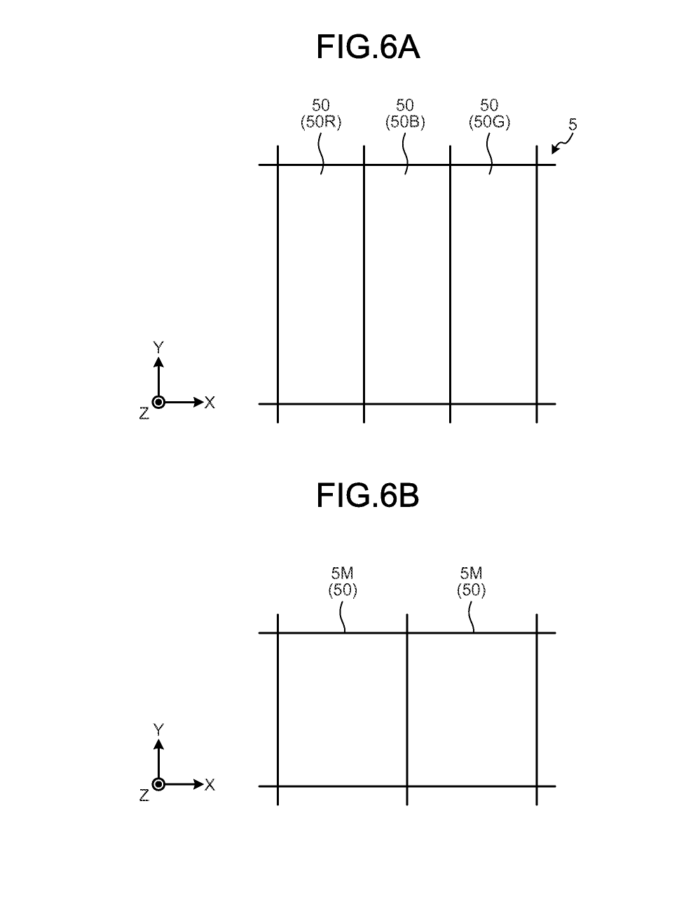

Next, the following describes a configuration example of the display unit 4 and the barrier unit 6 in detail. FIG. 4 is a schematic cross-sectional view representing a cross-sectional structure of a module to which the display unit and the barrier unit are mounted. FIG. 5 is a circuit diagram representing a pixel array of the display unit. FIG. 6A is a schematic diagram of the pixel in performing color display. FIG. 6B illustrates a pixel in performing monochrome display. To clearly illustrate the structure, the display unit 4 and the barrier unit 6 are represented as a flat surface in FIG. 4. As illustrated in FIG. 4, in the display device 1, the barrier unit 6 is laminated on the display unit 4.

The display unit 4 includes a pixel substrate 20, a counter substrate 30 arranged being opposed to the pixel substrate 20 in a direction orthogonal to the surface thereof, and a liquid crystal layer 60 interposed between the pixel substrate 20 and the counter substrate 30.

The pixel substrate 20 includes a TFT substrate 21 as a circuit board and a plurality of pixel electrodes 22 arranged in a matrix on the TFT substrate 21. On the TFT substrate 21, wiring is formed by a thin film transistor (TFT) element Tr of each pixel Pix illustrated in FIG. 5, a pixel signal line SGL that supplies an image signal to each of the pixel electrodes 22, a scanning signal line GCL that drives each TFT element Tr, and the like. The pixel signal line SGL extends on a surface parallel to the surface of the TFT substrate and supplies an image signal for displaying an image to a pixel. The pixel substrate 20 illustrated in FIG. 5 includes a plurality of pixels Pix arrayed in a matrix. The pixel Pix includes the TFT element Tr and a liquid crystal element LC. The TFT element Tr includes a thin film transistor. In this example, the TFT element Tr includes an n-channel metal oxide semiconductor (MOS) TFT. The source of the TFT element Tr is connected to the pixel signal line SGL, the gate thereof is connected to the scanning signal line GCL, and the drain thereof is connected to an end of the liquid crystal element LC. The liquid crystal element LC is connected to the drain of the TFT element Tr at one end and connected to a drive electrode 33 at the other end.

The pixel Pix is connected to the other pixels Pix belonging to the same row on the pixel substrate 20 via the scanning signal line GCL. The scanning signal line GCL is connected to a gate driver, and a scanning signal Vscan is supplied from the gate driver. The pixel Pix is connected to the other pixels Pix belonging to the same column on the pixel substrate 20 via the pixel signal line SGL. The pixel signal line SGL is connected to a source driver, and an image signal Vpix is supplied from the source driver. The pixel Pix is also connected to the other pixels Pix belonging to the same row on the pixel substrate 20 via the drive electrode 33. The drive electrode 33 is connected to a drive electrode driver, and a drive signal Vcom is supplied from the drive electrode driver. That is, in this example, the pixels 50 belonging to the same row share one drive electrode 33.

The display unit 4 applies the scanning signal Vscan from the gate driver to the gate of the TFT element Tr of the pixel 50 via the scanning signal line GCL illustrated in FIG. 5 to sequentially select, as a display drive target, a row (one horizontal line) of the pixels 50 formed in a matrix on the pixel substrate 20. The display unit 4 supplies, via the pixel signal line SGL illustrated in FIG. 5, the image signal Vpix from the source driver to each pixel 50 constituting one horizontal line sequentially selected. In these pixels 50, display of one horizontal line is performed according to the supplied image signal Vpix. The display unit 4 applies the drive signal Vcom to drive the drive electrode 33.

As described above, the display unit 4 drives the scanning signal line GCL to perform line-sequential scanning in a time division manner, so that one horizontal line is sequentially selected. The display unit 4 supplies the image signal Vpix to the pixel 50 belonging to one horizontal line to perform display for each horizontal line. When performing the display operation, the display unit 4 applies the drive signal Vcom to a block including the drive electrode 33 corresponding to each horizontal line.

The counter substrate 30 includes a glass substrate 31, a color filter 32 formed on one surface of the glass substrate 31, and a plurality of drive electrodes 33 formed on the surface of the color filter 32 opposite to the glass substrate 31. A polarizing plate 35 is arranged on the other surface of the glass substrate 31. The barrier unit 6 is laminated on the surface of the polarizing plate 35 opposite to the glass substrate 31 side.

In the color filter 32, for example, color filters colored in three colors such as red (R), green (G), and blue (B) are periodically arranged, and a set of the three colors “R”, “G”, and “B” is associated with each of the above-described pixels 50 illustrated in FIG. 5. Specifically, as illustrated in FIG. 6A, one pixel as a unit forming a color image, that is, a unit pixel 5, includes a plurality of sub-pixels 50, for example. In this example, the unit pixel 5 includes a sub-pixel 50R displaying “R”, a sub-pixel 50B displaying “B”, and a sub-pixel 50G displaying “G”. The sub-pixels 50R, 50B, and 50G included in the unit pixel 5 are arranged in the X direction, that is, the row direction of the display device 1. The color filter 32 faces the liquid crystal layer 60 in a direction orthogonal to the TFT substrate 21. The color filter 32 may have another color combination as long as it is colored in different colors.

The unit pixel 5 may have the sub-pixels of one color or a plurality of colors. When a reflective liquid crystal display device only supports monochrome display, as illustrated in FIG. 6B, one pixel as a unit forming a monochrome image, that is, a unit pixel 5M, is the pixel 50 (corresponding to the sub-pixel 50 in the color image). The unit pixel 5 is a basic unit for displaying the color image, and the unit pixel 5M is a basic unit for displaying the monochrome image.

The drive electrode 33 according to the embodiment functions as a common drive electrode (counter electrode) of the display unit 4. In the embodiment, arrangement is such that one drive electrode 33 corresponds to one pixel electrode 22 (pixel electrode 22 constituting one row). The drive electrode 33 may be a plate-shaped electrode common to a plurality of pixel electrodes 22. The drive electrode 33 according to the embodiment faces the pixel electrode 22 in a direction orthogonal to the surface of the TFT substrate 21, and extends in a direction parallel to a direction along which the pixel signal line SGL extends. A drive signal having an AC rectangular waveform is applied to the drive electrode 33 from the drive electrode driver via a contact conductive pole having electrical conductivity (not illustrated).

The liquid crystal layer 60 modulates light passing therethrough according to the state of an electric field. For example, for the liquid crystal layer 60, used are liquid crystals in various modes such as a twisted nematic (TN) mode, a vertical alignment (VA) mode, and an electrically controlled birefringence (ECB) mode.

An orientation film may be arranged between the liquid crystal layer 60 and the pixel substrate 20, and between the liquid crystal layer 60 and the counter substrate 30. An incident side polarizing plate may be arranged on the lower surface side of the pixel substrate 20.

Next, the barrier unit 6 includes a TFT substrate 121 as a circuit board, a plurality of unit region electrodes 122 arranged in columns on the TFT substrate 121, a glass substrate 131, a plurality of drive electrodes 133 arranged on the unit region electrode 122 side of the glass substrate 131, and a polarizing plate 135 arranged on the other surface of the glass substrate 131. A liquid crystal layer 160 is filled in a region between a surface on the drive electrode 133 side of the glass substrate 131 and a surface on the unit region electrode 122 side of the TFT substrate 121. The barrier unit 6 basically has a configuration similar to that of the display unit 4 except that the pixel electrode 22 of the display unit 4 is replaced with the unit region electrode 122 and the color filter 32 is not arranged. An orientation film may be arranged between the liquid crystal layer 160 and the TFT substrate 121, and between the liquid crystal layer 160 and the glass substrate 131. An incident side polarizing plate may be arranged on the lower surface side of the TFT substrate 121, that is, on the display unit 4 side.

The unit region electrode 122 has a shape similar to that of the unit region 150 illustrated in FIG. 3, that is, an elongated plate shape extending along the first direction. The unit region electrodes 122 are arranged in columns in the second direction.

The display unit 4 and the barrier unit 6 have the configuration as described above. By switching a voltage to be applied to the pixel electrode 22 and the unit region electrode 122 on the basis of a signal from the control unit 9, the display unit 4 can display an image and the barrier unit 6 can display a pattern in which a line extending in the first direction is arrayed in the second direction at respective intervals.

Relative Positions of Display Unit 4 and Barrier Unit 6

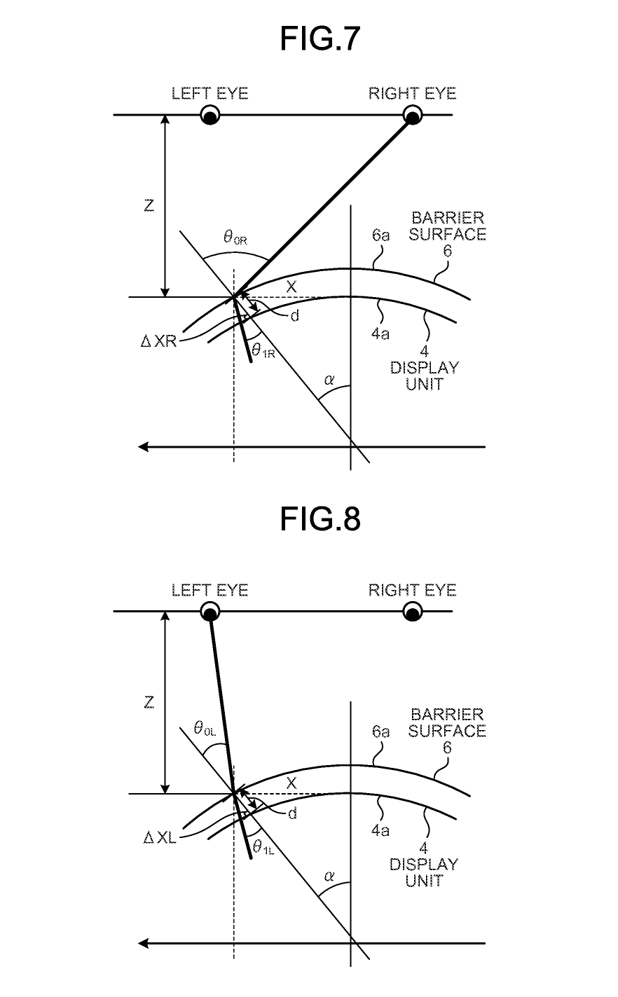

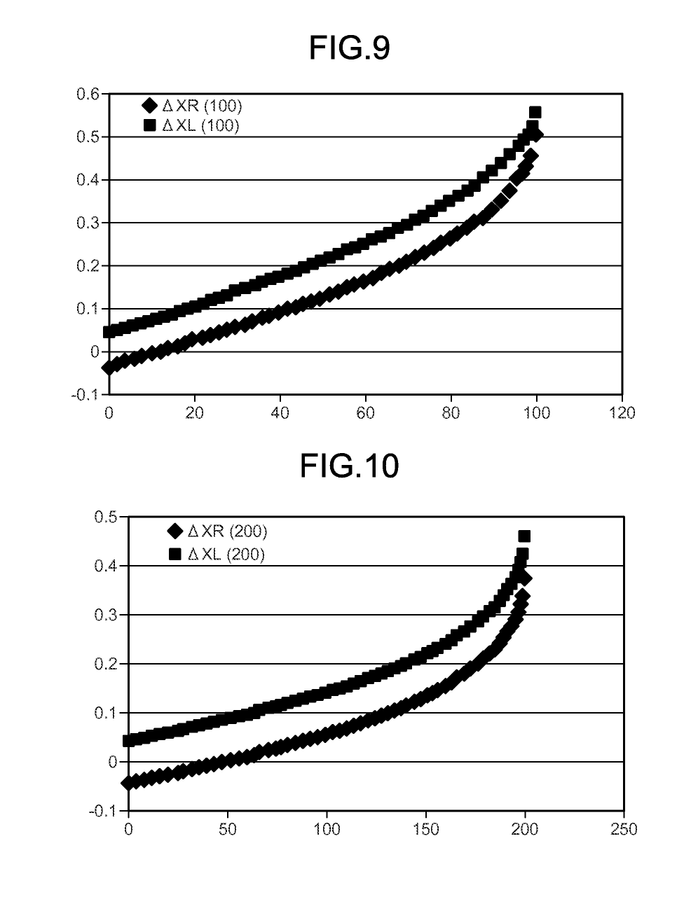

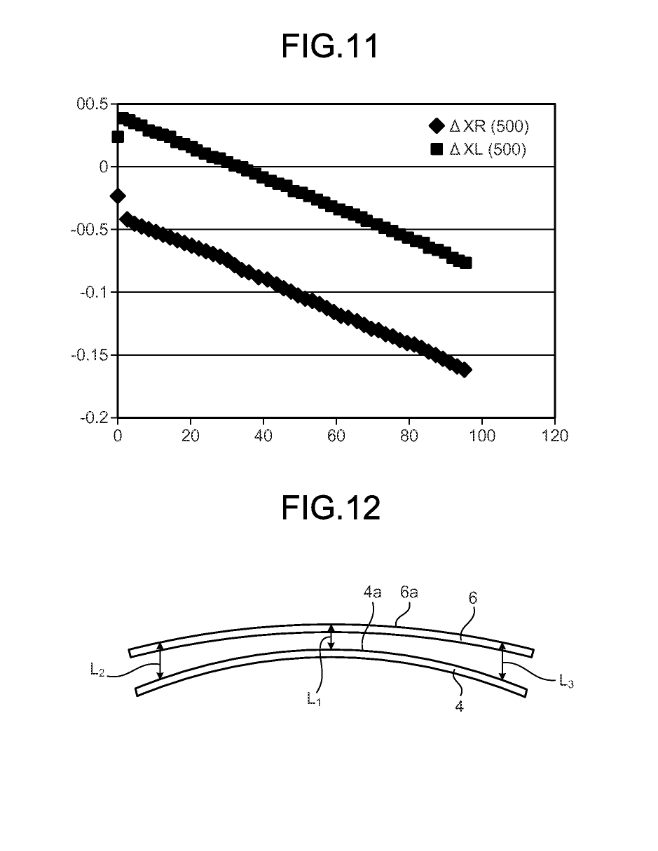

The following describes the relative positions of the display unit 4 and the barrier unit 6 in the second direction with reference to FIG. 7 to FIG. 12. FIG. 7 illustrates a relation of parameters for an image at a predetermined position of the display device when viewed with the right eye. FIG. 8 illustrates a relation of parameters for an image at the predetermined position of the display device when viewed with the left eye. FIG. 9 illustrates a relation of the shift in distance between the position of a pixel perceivable at the predetermined position and a line extending in a normal direction of the first surface from the predetermined position. FIG. 10 illustrates the relation of the shift in distance between the position of the pixel perceivable at the predetermined position and the line extending in the normal direction of the first surface from the predetermined position. FIG. 11 illustrates the relation of the shift in distance between the position of the pixel perceivable at the predetermined position and the line extending in the normal direction of the first surface from the predetermined position in a case in which the surface is flat. FIG. 12 is a side view illustrating a relation between the display unit and the barrier unit.

As described above, in the display device 1 according to the embodiment, the first surface 4a of the display unit 4 and the second surface 6a of the barrier unit 6 make a curved line in the second direction. It is assumed that the second surface 6a forms an arc, and the following describes a relation between the position of the first surface 4a on which an image visible with the right eye is displayed and the position of the first surface 4a on which an image visible with the left eye is displayed, at a target position of the second surface 6a (the unit region 150 that transmits light).

In the embodiment, as illustrated in FIG. 7 and FIG. 8, a distance from the center of the second surface 6a to the target position in the second direction is denoted by X, a distance from the target position to a user (viewer) (a distance in a direction orthogonal to a tangent line at the center of the second surface 6a) is denoted by Z, and an opening angle from the center to the target position is denoted by α on the curved surface of the second surface 6a.

As illustrated in FIG. 7, when the target position is viewed with the right eye, the incidence angle of light to the right eye is θ_{0R}, and the refraction angle of light to the right eye is θ_{1R}. When the distance between the first surface 4a and the second surface 6a along a normal line at the target position is denoted by d, a shift amount ΔXR between the position of the image visible with the right eye at the target position (position on the first surface 4a) and the normal line at the target position is given by the equation below:

ΔXR=d tan(θ_{1R}).

As illustrated in FIG. 8, when the target position is viewed with the left eye, an incidence angle of light to the left eye is θ_{0L}, and a refraction angle of light to the left eye is θ_{1L}. In this case, a shift amount ΔXL between the position of the image visible with the left eye at the target position (position on the first surface 4a) and the normal line at the target position is given by the equation below:

ΔXL=d tan(θ_{1L}).

That is, when viewing the target position, the user can see the image displayed at a position distant from the normal line at the target position by ΔXR with the right eye and can see the image displayed at a position distant from the normal line at the target position by ΔXL with the left eye. Accordingly, with the images displayed at the respective positions to generate a parallax, an image three-dimensionally visible is displayed at the target position.

In the display device 1 according to the embodiment, the first surface 4a and the second surface 6a make a curved surface, so that the relation between the shift amount ΔXR and the shift amount ΔXL changes with the position in the second direction. FIG. 9 and FIG. 10 illustrate a result obtained by measuring a relation among a movement amount from the center, the shift amount ΔXR, and the shift amount ΔXL on the basis of the relations described above.

FIG. 9 illustrates a result obtained by measuring the shift amount ΔXL and the shift amount ΔXR at different positions in a case in which the radius of the curvature of the second surface 6a is 100 mm. FIG. 10 illustrates a result obtained by measuring the shift amount ΔXL and the shift amount ΔXR at different positions in a case in which the radius of the curvature of the second surface 6a is 200 mm. In FIGS. 9 and 10, the length (width) of a pixel in the second direction is 90 μm, the suitable viewing distance is 350 mm, and the interocular distance is 60 mm. FIG. 11 illustrates a result obtained by measuring the shift amount ΔXL and the shift amount ΔXR at different positions in a case in which the second surface 6a is a flat surface, for comparison.

As illustrated in FIG. 11, in a case in which the surface is flat, the shift amount ΔXL and the shift amount ΔXR are constant. In contrast, as illustrated in FIG. 9 and FIG. 10, in a case in which the surface is a curved surface, an increase in the shift amount ΔXL and the shift amount ΔXR becomes smaller toward the end of the screen when the distance d is constant. The difference between the shift amount ΔXL and the shift amount ΔXR is also kept smaller. Accordingly, light is difficult to separate from the center of the pixel 50, so that reverse vision is easily generated. That is, 3D crosstalk increases.

On the other hand, as illustrated in FIG. 12, a relation between the shapes of the display unit 4 and the barrier unit 6 in the display device 1 according to the embodiment is such that the distance between the first surface 4a and the second surface 6a varies with the position in the second direction. Specifically, a distance L₁ between the first surface 4a and the second surface 6a at the center in the second direction is made shorter than a distance L₂ and a distance L₃ between the first surface 4a and the second surface 6a at the ends in the second direction. The distance between the first surface 4a and the second surface 6a gradually varies in the second direction. Accordingly, in the display device 1, the distance between the first surface 4a and the second surface 6a becomes larger toward the ends than the center in the second direction. The distance between the first surface 4a and the second surface 6a means the distance between the first surface 4a and the second surface 6a in the normal direction. The first surface 4a and the second surface 6a make a curved line in the second direction, so that the normal direction varies with the position in the second direction. The distance in the normal direction may be based on either the normal line of the first surface 4a or the normal line of the second surface 6a.

As illustrated in FIG. 12, in the display device 1, the values of the shift amount ΔXL and the shift amount ΔXR in the above-described equations at the ends are made larger by making the distance L₁ smaller than the distances L₂ and L₃, that is, by making the distances at the ends longer. Accordingly, the difference between the shift amount ΔXL and the shift amount ΔXR can be prevented from being smaller at the ends, and the light from the center of the pixel 50 can separately reach eyes after passing through the unit region 150 (opening) that transmits the light in the barrier unit 6. Accordingly, the reverse vision can be reduced and the 3D crosstalk can be reduced.

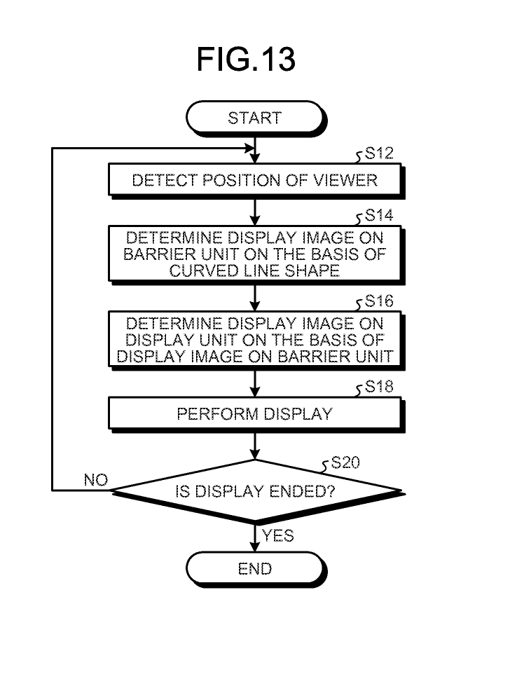

FIG. 13 is a flowchart illustrating an example of the operation of the display device. The display device 1 can control an operation of each part through the control unit 9 to perform the process in FIG. 13. The control unit 9 acquires an image imaged by the imaging unit 8 and an image to be displayed, and causes the display device 1 to display an image perceivable by a user as a three-dimensional image using the display unit 4 and the barrier unit 6. The display device 1 detects the position of the viewer (user) at Step S12. Specifically, the display device 1 specifies the positions of the left and right eyes of the user by acquiring the image through the imaging unit 8 and analyzing the acquired image.

After detecting the position of the viewer at Step S12, the display device 1 determines a display image of the barrier unit 6 on the basis of the curved line shape at Step S14. Specifically, the display device 1 determines a region that transmits an image for the right eye and a region that transmits an image for the left eye, on the basis of the distance between the first surface 4a of the display unit 4 and the second surface 6a of the barrier unit 6 at different positions in the second direction, and the position of the viewer, thereby setting each of the regions as a light transmitting region. The display device 1 sets, as a light blocking region, a region through which the image for the right eye can reach the left eye, a region through which the image for the left eye can reach the right eye, and as necessary, a region not displaying an image and through which the light can reach at least one of the right eye and the left eye. As described above, the display device 1 determines the image in which the light transmitting region and the light blocking region are combined, as an image to be displayed on the barrier unit 6.

After determining the image to be displayed on the barrier unit 6 at Step S14, the display device 1 determines a display image on the display unit 4 based on the display image on the barrier unit 6 at Step S16. The display device 1 acquires information of the image to be displayed, and determines, as a display image, an image in which the image for the right eye or the left eye is arranged at a position from which light reaches the right eye or the left eye, respectively, through the light transmission region of the barrier unit 6. In this case, the display device 1 adjusts its display position to generate a predetermined parallax between a pixel of the image for the right eye and the corresponding pixel of the image for the left eye when the viewer views the display image.

After determining the image to be displayed on the display unit 4 at Step S16, the display device 1 performs display at Step S18. That is, the display device 1 displays, on the display unit 4, an image in which the image for the right eye and the image for the left eye are divided into regions to be alternately arranged in the second direction. The display device 1 displays, on the barrier unit 6, an image patterned into the light transmitting region and the light blocking region so that the image for the right eye is displayed to the right eye and the image for the left eye is displayed to the left eye, that is, an image that blocks a position through which the image for the right eye is visible with the left eye and a position through which the image for the left eye is visible with the right eye. Accordingly, the display device 1 displays the image visually perceivable as a three-dimensional image to the viewer (user) at the position detected at Step S12.

After performing the display at Step S18, the display device 1 determines whether to end the display at Step S20. If the display device 1 determines not to end the display at Step S20 (No at Step S20), the process returns to Step S12 and the above-described process is performed again. The display device 1 repeats the process until it ends the display. If the display device 1 determines to end the display at Step S20 (Yes at Step S20), it ends the process.

As described above, by considering the relative position of the first surface 4a and the second surface 6a, the display device 1 adjusts the image to be displayed on the display unit 4 and the arrangement of the light transmitting region and the light blocking region in the barrier unit 6 to appropriately display an image visually perceivable as a three-dimensional image, even when the distance between the first surface 4a and the second surface 6a varies with the position in the second direction.

The length in the second direction of the unit region 150 of the barrier unit 6 may be preferably 0.5 time or more and 1.5 times or less the length of the pixel 50 of the display unit 4. The length (width) of the unit region 150 is adjusted to be within a certain range with respect to the width of the pixel 50, so that the arrangement of the unit region 150 that blocks light can be easily controlled.

In the second direction, the length of the unit region 150 of the barrier unit 6 is preferably shorter than the length of the pixel 50 of the display unit 4. For example, in the second direction, two or more pixels are preferably arranged on the barrier unit 6 in a range in which one pixel is arranged on the display unit 4. Accordingly, the image visible with the right eye and the image visible with the left eye by the user can be more finely controlled, so that it can be prevented that the image for left eye is visible with the right eye and the image for right eye is visible with the left eye, that is, the reverse vision can be reduced.

In the display device 1 according to the embodiment, a liquid crystal panel is used as the barrier unit 6 to adjust the position at which light is blocked. However, the embodiment is not limited thereto. The display device 1 may fix the position at which the light is blocked and may provide, as the barrier unit 6, a light shielding film such as a metal film or an inorganic film at a position at which the light is blocked. The light shielding film may be provided on the display unit 4 side surface of a substrate provided on the first surface 4a side of the display unit 4, may be provided on the first surface 4a of the display unit 4, may be provided on the surface opposite to the first surface 4a of the display unit 4, and may be provided on a surface of the polarizing plate of the display unit 4.

The display device 1 according to the embodiment displays a three-dimensional image using what is called a parallax barrier system provided with the barrier unit 6 that switches between the transmitting and blocking of the light to perform blocking so that different images are viewed with the right eye and the left eye while the image for the left eye is not viewed with the right eye and the image for the right eye is not viewed with the left eye. However, the embodiment is not limited thereto. In the display device 1, a liquid crystal lens may be arranged in a two-dimensional array instead of the barrier unit 6 and a refractive index of the liquid crystal lens may be adjusted to generate a parallax in each part of an image that reaches the right eye and an image that reaches the left eye. Alternatively, a liquid lens may be used instead of the liquid crystal lens. In a case in which the position of the user is substantially constant, a lenticular lens may be arranged instead of the liquid crystal lens. As described above, a liquid crystal lens, a liquid lens, or the like is used to cause the parallax, so that the light may be utilized without being blocked. Accordingly, the light output from the backlight 2 can be efficiently used.

The display device 1 according to the embodiment displays an image perceivable as a three-dimensional image while reducing the reverse vision, by having the varying distance between the first surface 4a and the second surface 6a with the position in the second direction, specifically, by having the distance between the first surface 4a and the second surface 6a at the ends in the second direction longer than the distance between the first surface 4a and the second surface 6a at the center in the second direction, that is, by separating the surfaces away from each other toward the ends. However, the embodiment is not limited thereto.

In the display device 1, the width (length in the second direction) of the pixel 50 of the display unit 4 and the width of the unit region 150 of the barrier unit 6 may vary with the position in the second direction. Specifically, when the width of the pixel 50 of the display unit 4 and the width of the unit region 150 of the barrier unit 6 at the end in the second direction are made shorter than the widths at the center in the second direction, the light can be easily separated, so that the reverse vision can be further reduced.

In the display device 1, the width in the second direction of the unit region 150 of the barrier unit 6 may be made shorter than the width in the second direction of the pixel 50 of the display unit 4. Specifically, a plurality of unit regions 150, preferably the unit regions 150 of an integer multiple of the pixel 50 may be arranged for one pixel 50, so as to adjust the position of the unit region 150 that transmits light and the position of the unit region 150 that blocks light. That is, in the display device 1, a shift amount in the second direction between the pixel 50 for displaying an image for the right eye or the left eye and the unit region 150 that transmits the image may be different at the ends in the second direction and the center in the second direction.

### 2. APPLICATION EXAMPLE

The following describes an application example of the display device 1 according to the embodiment and a modification thereof. The display device 1 according to the embodiment may be applied to an electronic apparatus of which surface is made into a curved surface and having a function for displaying a three-dimensional image. For example, the electronic apparatus is a car navigation device arranged on a windshield of a vehicle, the windshield working as a display surface. In addition to the car navigation device, examples include a mobile phone, a clock with a display device, a watch with a display device, a personal computer, a liquid crystal television, a view finder-type or a monitor direct viewing-type video tape recorder, a pager, an electronic organizer, an electronic calculator, a word processor, a workstation, a videophone, and a POS terminal device.

Aspects of Present Disclosure

The present disclosure includes the following aspects:
(1) A display device comprising:
   a display unit comprising a first surface having a curved surface shape which is a straight line in a first direction and is a curved line in a second direction orthogonal to the first direction; and
   a parallax adjustment unit that comprises a second surface having a curved surface shape which is a straight line in the first direction and is a curved line in the second direction, and is arranged on an image-displaying surface side of the display unit, wherein
   a distance between the first surface and the second surface at center in the second direction is shorter than a distance between the first surface and the second surface at an end in the second direction.
(2) The display device according to claim 1, wherein the parallax adjustment unit includes a display panel in which unit regions extending in the first direction are arranged in columns in the second direction.
(3) The display device according to claim 2, wherein the parallax adjustment unit switches the unit regions between being transmissive or non-transmissive.
(4) The display device according to claim 2, wherein the parallax adjustment unit includes a liquid crystal lens that changes a refractive index of the unit regions.
(5) The display device according to claim 2, wherein a width of the unit region at the end in the second direction is shorter than a width of the unit region at the center in the second direction in the parallax adjustment unit.
(6) The display device according to claim 2, further comprising:
   a control unit that controls driving of the display unit and the parallax adjustment unit, wherein
   the control unit adjusts a relative relation between an image to be displayed on the display unit and the unit regions of the parallax adjustment unit based on a curvature of the first surface and the second surface in the second direction.
(7) The display device according to claim 1, wherein a curved line shape in the second direction of the first surface and the second surface is an arc.

In the display device according to the present disclosure, light can be easily separated even at the ends by making the distance between a first surface and a second surface longer at the ends in a second direction at which the light is difficult to be separated. As described above, the light can be easily separated, so that the pixels of the display unit can be separated from each other. Accordingly, also at the ends, an image for the right eye and an image for the left eye can be separated, thereby reducing crosstalk. The image for the right eye and the image for the left eye can be separated, so that a stereoscopic image can be displayed also at the ends more appropriately.

The display device according to the present disclosure can more appropriately display an image perceivable as a three-dimensional image by a user, even when a display surface on which the image is displayed has a curved surface shape which is a straight line in one direction and is a curved line in the other direction orthogonal to the former direction.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display device comprising:
a display unit comprising a first surface having a curved surface shape which is a straight line in a first direction and is a curved line in a second direction orthogonal to the first direction; and
a parallax adjustment unit that comprises a second surface having a curved surface shape which is a straight line in the first direction and is a curved line in the second direction, and is arranged on an image-displaying surface side of the display unit, wherein
a distance between the first surface and the second surface at center in the second direction is shorter than a distance between the first surface and the second surface at an end in the second direction.

2. The display device according to claim 1, wherein the parallax adjustment unit includes a display panel in which unit regions extending in the first direction are arranged in columns in the second direction.

3. The display device according to claim 2, wherein the parallax adjustment unit switches the unit regions between being transmissive or non-transmissive.

4. The display device according to claim 2, wherein the parallax adjustment unit includes a liquid crystal lens that changes a refractive index of the unit regions.

5. The display device according to claim 2, wherein a width of the unit region at the end in the second direction is shorter than a width of the unit region at the center in the second direction in the parallax adjustment unit.

6. The display device according to claim 2, further comprising:
a control unit that controls driving of the display unit and the parallax adjustment unit, wherein
the control unit adjusts a relative relation between an image to be displayed on the display unit and the unit regions of the parallax adjustment unit based on a curvature of the first surface and the second surface in the second direction.

7. The display device according to claim 1, wherein a curved line shape in the second direction of the first surface and the second surface is an arc.
